(19) United States
(12) Patent Application Publication
(10) Pub. No.: US 2012/0323774 A1
(43) Pub. Date: Dec. 20, 2012

(54) POINT OF SALE (POS) SYSTEMS AND METHODS FOR MAKING TAX PAYMENTS

(76) Inventors: Jeffrey GARDNER, Nashville, TN (US); Jeffrey Slusser, Columbia, TN (US)

(21) Appl. No.: 13/160,918

(22) Filed: Jun. 15, 2011

(51) Int. Cl. G06Q 40/00

(52) U.S. Cl. 705/40

(57) ABSTRACT

A standalone device, systems, and methods of using them that are dedicated for making tax payments directly to a government authority without being coupled with electronic filing of tax returns or other filing or processing documents.

### BACKGROUND OF THE INVENTION

1. Field of the Invention

The present invention relates generally to electronic financial transactions, and more particularly to systems and methods for electronic payment transactions for making tax payments to government authorities from a remote location.

2. Description of the Prior Art

Generally, it is known in the art to conduct financial transactions using a network-based system for transmitting and receiving electronic payments. By way of example, it is known to make electronic payments over a network such as the Internet by transactions involving payments from individuals' and business' credit, debit, prepaid, ATM card, PayPal account, Bill Me Later account, or other electronic payment methods (“Electronic Payment”) for various types of payment transactions.

More specifically, concerning government-related transactions, particularly in the US, most systems do not provide for individual payments to be made using credit cards or other electronic payment methods, such as emerging electronic payment methods for making payments through non-traditional third parties other than banks, credit cards, etc., even though they are commonly used in online commerce for making payments for everything from services to goods. While it is known in the art to use point-of-sale (POS) devices for making payments with credit cards, debit cards, or electronic funds transfer (EFT) for various transactions, these documents do not provide POS devices for making payments of taxes, for example to the federal government in the United States. Furthermore, it is known in the art to provide payment of taxes through a website over the internet or computer-downloadable software using EFT payment or credit card payment, they do not provide for a standalone device or system.

Also, and by way of related example, presently, the US Internal Revenue Service (IRS) and other state income tax departments allow individuals to make electronic payments using their credit cards and debit cards (“Cards”) through various third party organizations. These third party organizations collect funds from a number of individuals by electronically charging their Cards. The organizations then make lump sum, bulk, pooled, or batch payments to the taxing authority, based on a separate payment file or multiple files, for all individuals paying within a specific time period using the third party's own bank accounts.

Examples of some relevant art documents that describe income tax preparation kiosks that receive and process user data and allow the user to pay at the kiosk with cash, credit or debit cards include the following:

US Pub. No. 20050038722 for Methods, Systems, and Computer Program Products for Processing and/or Preparing a Tax Return and Initiating Certain Financial Transactions.

A method of processing a tax return, comprising:

Receiving tax information associated with a taxpayer, wherein the tax information is in a plurality of formats;
Converting the tax information into a common electronic format and determining if the tax information is sufficient to generate a tax return therefrom.
Processing the tax information to generate a tax return if the tax information has been determined to be sufficient.
Also describes that the data processing system may be embodied as a self-serve tax kiosk or a self-standing machine.

US Pub. No. 20020013747 for a Method and Apparatus for Electronic Filing of Income Tax Returns by a Taxpayer

Describes a method for taxpayer self-preparation of income tax returns comprising the steps of entering, by the taxpayer, data into a publicly accessible electronic data processing machine, converting taxpayer data into a electronic tax return data file and transmitting the taxpayer data and the data file to a remote processing center by electronic means
Further describes that the business process system looks like a free-standing ATM, internet access kiosk or check cashing kiosk. The invention is described as a self-service tax preparation and electronic filing (e*file) device for Federal and State income tax returns
Further describes that the device has a magnetic card reader for credit/debit card payments

US Pub. No. 20060010050 for Income Tax Preparation Kiosk

Claims a kiosk that receives and scans data to be processed by the data base/individuals receiving the data input at the kiosk or some other remote location.
Further describes that the kiosk will produce a copy of documents pertaining to the tax year requested by the customer.
Further claims a method for inputting W2's, scanning social security cards, drivers licenses/any other pertinent information for income tax.
Further describes that the customers will be able to pay at the kiosk with credit or debit cards

Further claims presenting the taxpayer with options for paying the tax comprises: filing the tax return electronically; and paying the tax via cash, credit/debit card, and/or an electronic transfer of funds.

U.S. Pub. No. 2008/0097878—System and method for payment of estimated tax due, which teaches a system and method for estimating and paying income taxes consisting of: a means of receiving financial information for an individual; calculating the estimated tax due on the individual's income; occasionally withdrawing an amount of money from the individuals' account; placing withheld funds in a secondary account until the funds available in the secondary account equal or exceed the estimated tax liability; transferring the final amount of money in the secondary account to the applicable taxing authority.

U.S. Pub. No 2002/0013747—Method and apparatus for electronic filing of income tax returns by a taxpayer, which teaches a method and free standing device to allow an individual to enter data, prepare tax returns, file tax returns, and remit payment or receive a refund. The method includes provisions for the applicable transfer of funds through a remote service provider, other third party, or by smart card.

U.S. Pat. No. 6,202,052—Fully-automated for tax reporting, payment and refund.

U.S. Pat. No. 6,697,787—System for collecting tax data, which teaches system in which an electronic intermediary processes, reports, and arranges for the appropriate transfer of funds in the form of payment or refund involving: receipt of tax data by the intermediary; processing of said data and subsequent preparation of tax return; filing the tax return; arranging for the appropriate transfer of funds (payment or refund).
U.S. Pub. No 2001/0037268—Fully-automated system for tax reporting, payment and refund and system for accessing tax information, which provides method and system for gathering information form sources to assemble tax information on individual taxpayers, preparing tax returns based on acquired information, filing the return with taxing authorities, and connecting to a financial institution to pay any liability or receive a refund.

### SUMMARY OF THE INVENTION

The present invention is directed to methods for processing payments electronically over a network-based system, such as Internet, phone, wireless communications, and other channels, wherein a third party or intermediary facilitates payment transactions in order to simplify and enable the processing of payments on behalf of individuals through all types of electronic, network-based payment methods without requiring payment integration by the payment recipient.

One aspect of the present invention provides a method for processing payments electronically over a network-based system including the steps of:

(a) providing a dedicated device for making payments directly to a government entity for receiving and remitting payments from individuals;

(b) initiating a transaction for making a payment on behalf of an individual;

(b) receiving electronic payment information or data and corresponding authorization for a government tax payment from an individual account, such as a credit card or debit card; and

(c) providing the electronic payment data directly to the government for immediate credit of the tax payment by the individual, without transmission or submission of any tax filing documentation at the time of the payment.

Significantly, the tax payment does not correspond to a tax filing component or data; rather, it is simply providing a direct payment to the government for tax or other government fees due by an individual via a freestanding, dedicated device.

A second aspect of the present invention is to provide systems and methods for making individualized electronic payments directly to government entities or agencies, such as the IRS, state tax departments or other government agency through a dedicated freestanding device that preferably is integrated with the government payment system(s) providing immediate credit for the payment by the individual without the requiring or including any tax filing documents. In one embodiment, an individual enters his/her unique taxpayer identification number, such as but not limited to social security number or other government-assigned taxpayer identification, and provide a credit card or debit card and its corresponding information for making an electronic payment via the dedicated device for receipt directly by the government.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a PRIOR ART flow diagram illustrating steps for making a payment to a government entity by an individual.

FIG. 2 is a flow diagram illustrating steps for making electronic payments by an individual directly to the government via a dedicated device, according to one embodiment of the present invention.

FIG. 3 is a PRIOR ART flow diagram.

FIG. 4A and FIG. 4B form a continuous (connected) flow diagram of PRIOR ART methods for credit card integrated file and bulk payment to payment recipient for an IRS example.

FIG. 5 is a schematic diagram showing a multiplicity of dedicated devices and networked connection for making the payments directly to the government by individuals and/or taxpayer entities represented by individuals using the devices.

### DETAILED DESCRIPTION

The term “payment” or “payments” as used hereinbelow in the detailed description of the invention and preferred embodiments is defined as a financial transaction that may either be a debiting from an account or a transfer initiated from that account.

Referring now to the drawings in general, the illustrations are for the purpose of describing a preferred embodiment of the invention and are not intended to limit the invention thereto. The present invention provides methods of electronically processing individual income tax payments from a remote location to the government tax payment authority.

Furthermore, it is known in the art to provide payment of taxes through a website over the internet or computer-downloadable software using EFT payment or credit card payment, they do not provide for a standalone device or system that is dedicated for making tax payments to a government authority as provided by the present invention with a kiosk or other standalone, dedicated device that is not coupled with preparation and filing of tax returns, tax forms, or other documentation associated with taxes.

Since the prior art set forth in the foregoing does not provide the solutions that continue to exist as a longstanding and unmet need, there remains a need for a system and methods for processing payments electronically from a remote location to simplify and enable the processing of payments only where individual users would not otherwise be able to participate or complete the transaction directly with the government entity, or where individual payments made through an electronic kiosk-type system or device would simplify the processing and extend the electronic payment options, separate and apart from filing any forms or tax documents. There also remains a need for facilitate individualized Electronic Payments to be made to government entities, such as the IRS, state tax departments remotely and without being coupled to tax filing documents.

The present invention provides a method for processing payments electronically over a network-based system including the steps of:

(a) providing a dedicated device for making payments directly to a government entity for receiving and remitting payments from individuals;

(b) initiating a transaction for making a payment on behalf of an individual;

(b) receiving electronic payment information or data and corresponding authorization for a government tax payment from an individual account, such as a credit card or debit card; and

(c) providing the electronic payment data directly to the government for immediate credit of the tax payment by the individual, without transmission or submission of any tax filing documentation at the time of the payment.

Significantly, a direct tax payment made using the dedicated device and methods of using same according to the present invention does not require and does not correspond to a tax filing component or data submitted therewith; rather, the direct payment to the government for tax or other government fees due by an individual via a freestanding, dedicated device includes submission of an electronic payment by an individual or corporate entity identified by and associated with a unique taxpayer identification.

Additionally, the present invention provides systems and methods for making individualized electronic payments directly to government entities or agencies, such as the IRS, state tax departments or other government agency through a dedicated freestanding device that preferably is integrated with the government payment system(s) providing immediate credit for the payment by the individual without the requiring or including any tax filing documents. In one embodiment, an individual enters his/her unique taxpayer identification number, such as but not limited to social security number or other government-assigned taxpayer identification, and provide a credit card or debit card and its corresponding information for making an electronic payment via the dedicated device for receipt directly by the government.

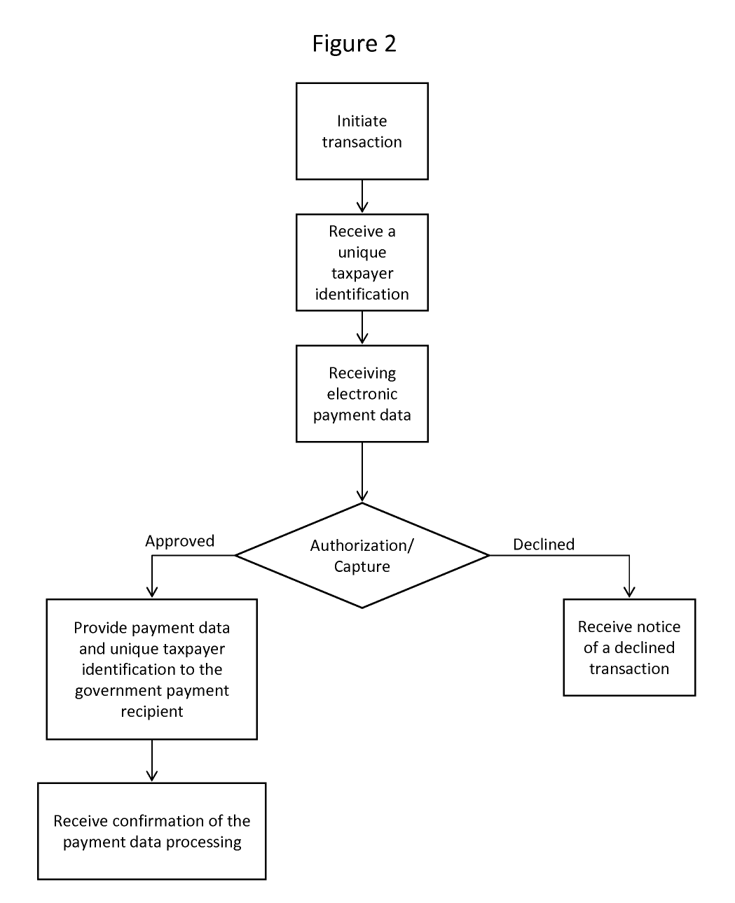

More specifically, as illustrated by the flow diagram of FIG. 2, the present invention provides a method for making electronic financial transactions for payments to government entities or agencies directly including the steps of: providing a network for making electronic data communications, including secure transmission of payment data for transmitting payments between a dedicated device, such as but not limited to a point of sale (POS) payment device and a government payment recipient, without including any tax filing or other tax documentation therewith; initiating a transaction over the network via the dedicated payment device for making an electronic payment on behalf of an individual taxpayer or taxpaying entity owing the government entity a tax payment or fee; the dedicated device operable for receiving authorization and data for electronic payment by the taxpayer; receiving a unique taxpayer identification; providing payment data and unique taxpayer identification to the government payment recipient relating to the tax payment made directly and without submission of corresponding tax documents for making a tax filing. Optionally, an additional step of receiving confirmation of the payment data processing by the payment recipient may be included, confirming the immediate credit of the payment to the taxes and/or fees owed to the government by the taxpayer. Alternatively and also optionally, an additional step of receiving notice of a declined transaction is provided.

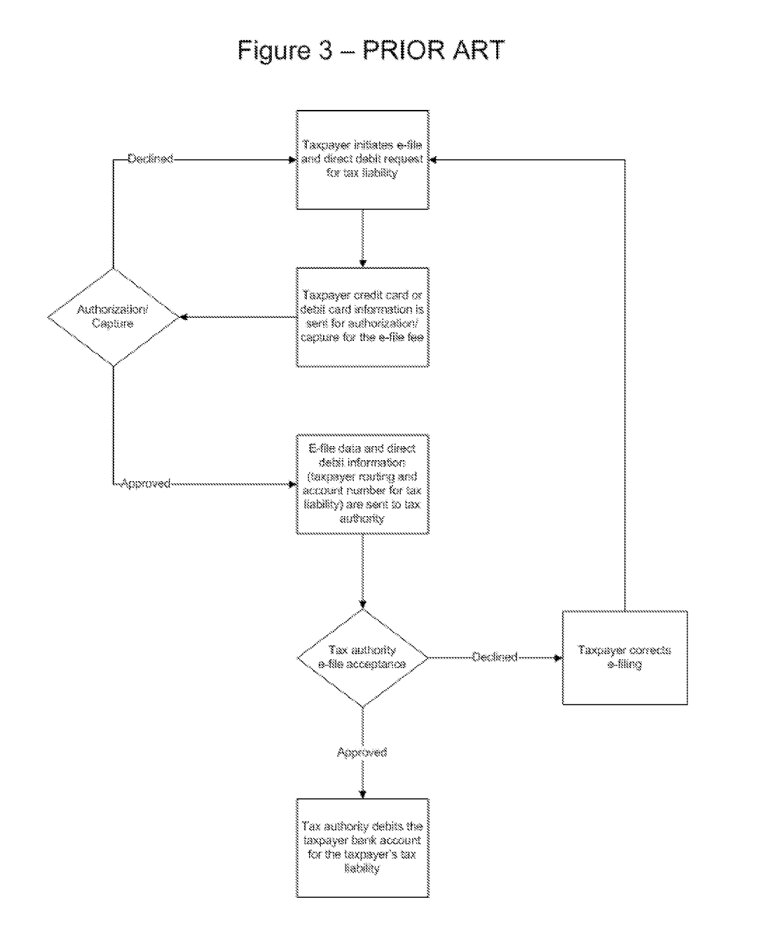

FIG. 3 is a PRIOR ART flow diagram illustrating a tax liability bank account direct debit (not credit card) process wherein the individual payor account information is provided to the payment recipient for a tax payment example.

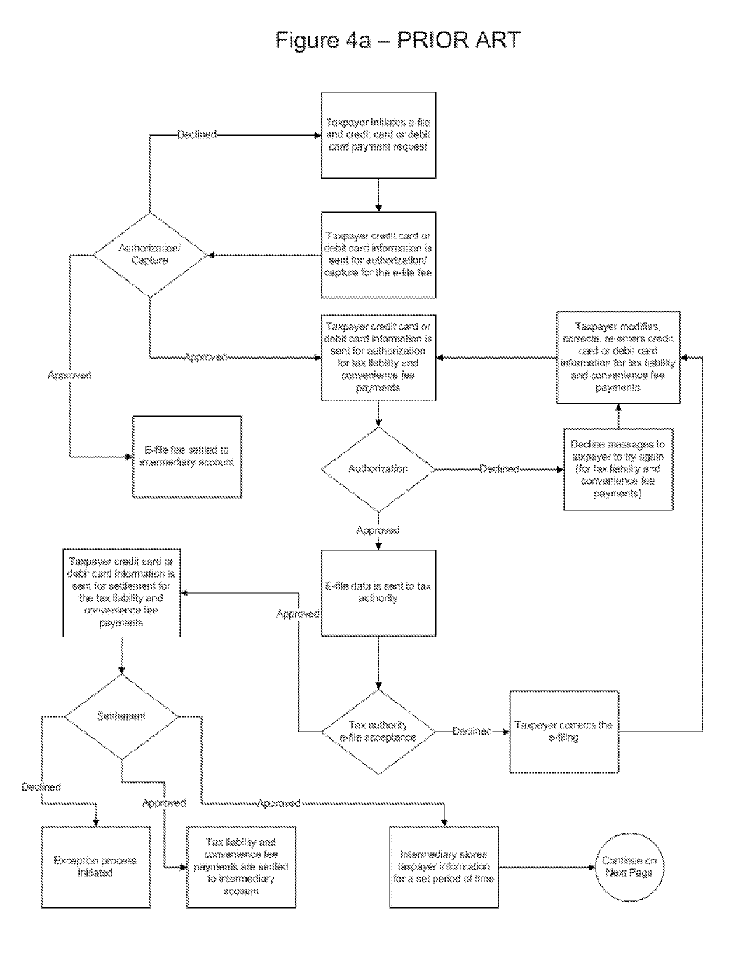

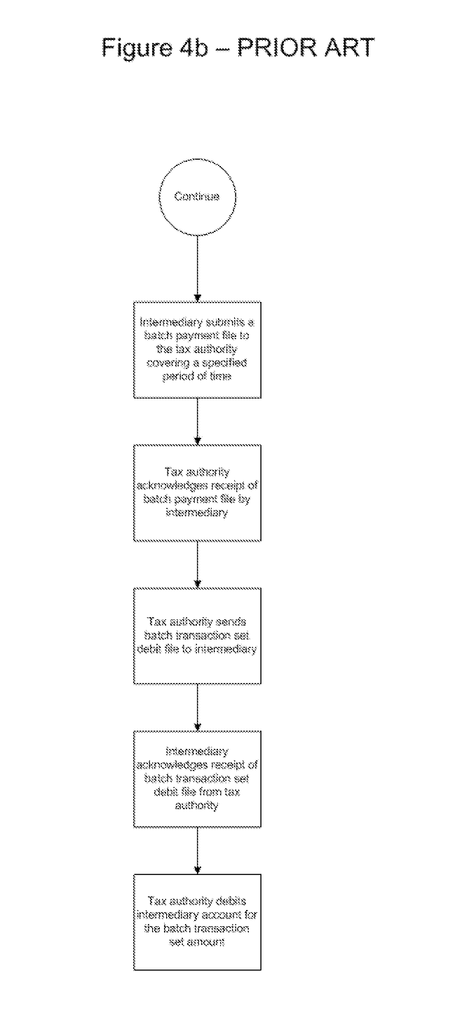

FIG. 4A and FIG. 4B form a continuous (connected) flow diagram of PRIOR ART methods for credit card integrated file and bulk payment to payment recipient for an IRS example. In this extended flow diagram, a credit card integrated file and bulk payment filer process is illustrated, including the individual payor (taxpayer) provides his/her own individual credit card or debit card information for making the payment directly to the payment recipient (IRS, in this example). Note that for reconciliation, the tax authority (payment recipient) requires integration for the electronic filing process and the credit card bulk filer process. If there is an intermediary, it must submit a batch payment file in order for the tax authority to reconcile taxpayer data to the bulk payment amount. In order to add other electronic payment methods (other than credit or debit card), the tax authority must make payment file modifications for each request. This adds development, testing, and costs for the tax authority, and thus, may prevent other forms of electronic payments from being accepted, including credit cards in some cases.

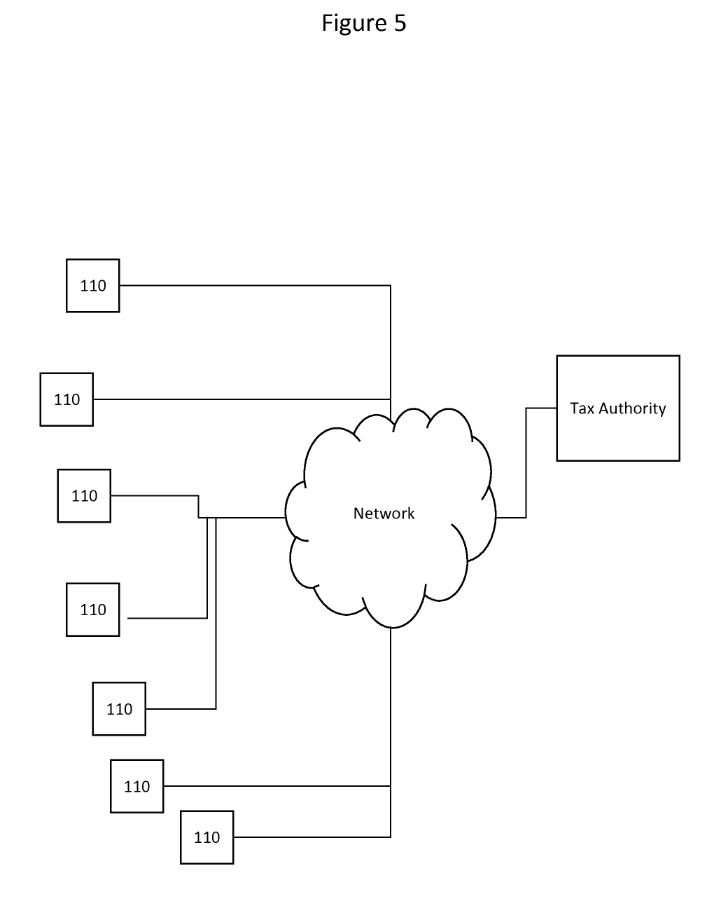

FIG. 5 is a schematic diagram showing a multiplicity of dedicated devices or terminals and networked connection for making the payments directly to the government by individuals and/or taxpayer entities represented by individuals using the devices. FIG. 5 illustrates configurations for the example of making a tax payment. Significantly, the government payment recipient does not require or accept a tax filing document at the time of receipt and acceptance of the electronic payment.

With the present invention methods, individuals are able to make electronic payments through any of the dedicated devices associated with the network for making secure payments directly to the government using a credit card or debit card, and by providing an unique taxpayer identification.

The taxpayer may use any of the dedicated devices or remote terminals or kiosks, and is not required to submit payments through the same dedicated device as with prior payments being submitted. Multiple payments for individual accounts with corresponding unique taxpayer identifications may be involved, wherein the tax payment is submitted directly for each entity by an authorized individual with a corresponding authorized credit card or debit card.

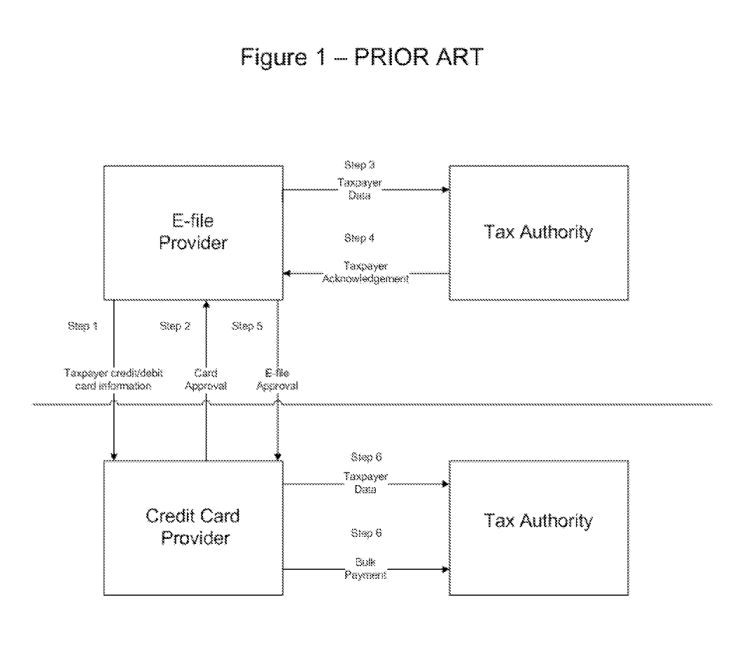

By contrast to the present invention, as illustrated by the PRIOR ART FIG. 1 flow diagram, it is known for individuals such as individual tax payers to make electronic filing of forms including payments. However, these transactions associated with the electronic filing and payment requires the government agency to collect funds from each individual by electronically debiting bank accounts individually or debit the intermediary account once for a batch of individual payments. It is a longstanding and unmet need that individual taxpayers cannot make credit card or debit card payments directly to the government via a dedicated device without coupling the payment to a tax filing or tax document submissions at the same time. Thus, the present invention solves the problems of the prior art by providing a dedicated device securely networked with government entities or agencies payment receiving systems that function to allow individual taxpayers to make a tax payment electronically without submitting a tax document or tax filing with it simultaneously.

The present invention provides for a technology supporting methods to facilitate electronic credit card and debit card payments to be made to the IRS or other government agency directly through such a freestanding, dedicated device or terminal, such as a POS device or kiosk that requires only the unique taxpayer identification and a credit card or debit card information that that taxpayer is authorized to use for making the payment. By way of example but not limitation, the network may be limited to IRS networks for making secure transmissions between the over 400 offices distributed throughout the US and the IRS central system or server(s) and the devices may be located at those offices. However, the devices may also be connected via more open networks while providing for secure payment transmissions using the credit card or debit card information and the unique taxpayer identification, all without coupling the payment with a tax filing or any tax document submission at the time of payment.

The present invention provides a method of completing electronic payments from individuals' and business' credit, debit, prepaid, ATM card, or other electronic payment methods, and combinations thereof, hereinafter defined and referred to as individually and collectively as electronic payments, to a taxing authority such as the IRS or state government, via any of the dedicated device(s) without submitting tax documents therewith. Preferably, immediate credit for the payment is provided by the government receiving entity for the tax payment made from the device, and the device provides an output or visual indicator of the confirmation of the successful payment and credit therefor.

Additionally, the present invention provides methods that facilitate individualized electronic payments to be made to the IRS, state tax departments, government agencies, and the like.

The present invention and preferred embodiments supporting best mode of application thereof as set forth in the foregoing, are supplied as examples and not intended to limit the scope of the invention thereto. By way of example and not limitation, applicable areas for the systems and methods of the present invention include the following: the public sector or government entities where individual taxpayer electronic payment is not available; the Federal government (e.g., individual income taxes, business taxes); state governments (e.g., individual income taxes, business taxes, sales and use tax, corporate filings, business licenses, other fees or licenses, etc.); local government (e.g., taxes, permits, court fees and fines, citations, etc; and combinations thereof.

With regard to federal and state income taxes, for example, the government will accept payment directly through the systems and methods of the present invention without validation of payment owed or tax filing documentation supporting the same. Since the government does not have confirmation of how much is owed for taxes at all times, for example with estimated quarterly taxes, the present invention provides that a taxpayer can provide for payment toward taxes owed without filing a return therewith.

Regarding the example of property taxes, the present invention provides for automated integrated remote payment of taxes directly—via check, credit card, etc. and received a notation automatically and immediately noted as paid, and the payment is made via the dedicated device (for example but not limitation, POS credit card system) integrated with government payment tax system, so that the system automatically updates payment records at the time the electronic payment is provided to indicate that they payment is received.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention as set forth in the claims.

What is claimed is:

1. A method for processing payments electronically over a network-based system comprising the steps of:
(a) providing a dedicated device for making payments directly to a government entity for receiving and remitting payments from individuals;
(b) initiating a transaction for making a payment on behalf of an individual;
(c) providing a unique taxpayer identification associated with the transaction payment;
(d) receiving electronic payment information or data and corresponding authorization for a government tax payment from an individual account; and
(e) providing the electronic payment data directly to the government for credit of the tax payment by the individual, without transmission or submission of any tax filing documentation at the time of the payment.

2. The method of claim 1, wherein the step of providing payment includes providing credit card or debit card information.

3. The method of claim 1, wherein the steps (a) through (d) are repeated from corresponding devices for a multiplicity of individuals and their respective tax accounts.

4. The method of claim 1, further including the step of providing a unique taxpayer identification associated with the tax payment.

5. A system for making direct electronic tax payments to governments comprising:
at least one dedicated device for receiving an unique taxpayer identification and credit card or debit card information;
wherein the device(s) are coupled to a network for securely, electronically transmitting the electronic payment directly to the government from the device(s) based upon the inputs provided by a taxpayer user, without including transmission of any tax filing documents.

6. The system of claim 5, wherein the dedicated device is a freestanding device.
